(19) United States
(12) Patent Application Publication
(10) Pub. No.: US 2019/0005207 A1
(43) Pub. Date: Jan. 3, 2019

(54) APPARATUS AND METHOD OF LAYERED LICENSING

(71) Applicant: QUALCOMM Incorporated, San Diego, CA (US)

(72) Inventors: Matthew HOHLFELD, San Diego, CA (US); Yin Ling LIONG, San Diego, CA (US); Giridhar MANDYAM, San Diego, CA (US); Matthew SMALL, San Diego, CA (US)

(21) Appl. No.: 16/105,594

(22) Filed: Aug. 20, 2018

Related U.S. Application Data
(63) Continuation of application No. 13/118,738, filed on May 31, 2011, now abandoned.

(51) Int. Cl. G06F 21/10; G06F 21/12; G06F 21/16

(52) U.S. Cl. CPC G06F 21/105; G06F 21/125; G06F 2221/0771; G06F 2221/0759; G06F 21/16

(57) ABSTRACT

A methodology and apparatus for layered licensing is described. A licensable item is detected on a device. A legacy license associated with the licensable item is accessed, wherein the legacy license corresponds to a legacy licensing policy. A layered license associated with the licensable item is accessed, wherein the layered license corresponds to a layered licensing policy. The legacy licensing policy and the layered licensing policy are integrated into an integrated license, and the integrated license is enforced.

### REFERENCE TO CO-PENDING APPLICATIONS FOR PATENT

The present Application for Patent claims the benefit of U.S. patent application Ser. No. 13/118,738, entitled “Apparatus and Method of Layered Licensing,” filed May 31, 2011, assigned to the assignee hereof, and expressly incorporated by reference herein in its entirety. The present Application for Patent is related to U.S. patent application Ser. No. 13/118,701, entitled “Apparatus and Method of In-Application Licensing,” filed May 31, 2011, assigned to the assignee hereof, and expressly incorporated by reference herein in its entirety.

### BACKGROUND

The present disclosure relates to communication devices, and more particularly, to providing improved apparatus and methods of managing licensed items, including content and/or a service.

Although the described aspects relate generally to communication devices, an example use case with mobile devices illustrates problems with current licensing models. Mobile operators or mobile device carriers play a major part in the telecommunication industry today. Initially, such mobile operators concentrated their efforts on generating revenue by increasing their subscriber base. However, it will be appreciated that in several countries, the scope for increasing the subscriber base has now become very limited, as the market has reached close to saturation point. As a result, the mobile operators have been branching into providing value added services to subscribers, in order to increase their revenue.

One means of generating increased revenue is through the sales of premium content and/or services to users, such as ringtones, wallpaper, games, etc. These items may be provided by the mobile operators themselves, or by business entities who may operate in collaboration with the mobile operators to provide such items. In some aspects, for example, the content and/or service items may be available for download to a user's communication device, such as a mobile device, upon payment of a fee.

Many benefits such as maximizing the potential earnings for sales may accrue upon recommending and distributing to users content and/or services that are of interest to the users. The user can have a better experience using the user's communication device in light of these content and/or services. Licensing of such content and/or services can provide an incentive for providers to create such offerings.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the present disclosure provides a method for licensing by detecting a licensable item on a device and accessing a legacy license associated with the licensable item. The legacy license corresponds to a legacy licensing policy. The method further includes accessing a layered license associated with the licensable item wherein the layered license corresponds to a layered licensing policy. The method further includes integrating the legacy licensing policy and the layered licensing policy into an integrated license, and enforcing the integrated license.

In another aspect, the present disclosure provides at least one processor for licensing. A first module detects a licensable item on a device. A second module accesses a legacy license associated with the licensable item, wherein the legacy license corresponds to a legacy licensing policy. A third module accesses a layered license associated with the licensable item, wherein the layered license corresponds to a layered licensing policy. A fourth module integrates the legacy licensing policy and the layered licensing policy into an integrated license. A fifth module enforces the integrated license.

In an additional aspect, the present disclosure provides a computer program product for licensing. A non-transitory computer-readable storage medium stores instructions. At least one instruction causes a computer to detect a licensable item on a device. At least one instruction causes the computer to access a legacy license associated with the licensable item, wherein the legacy license corresponds to a legacy licensing policy. At least one instruction causes the computer to access a layered license associated with the licensable item, wherein the layered license corresponds to a layered licensing policy. At least one instruction causes the computer to integrate the legacy licensing policy and the layered licensing policy into an integrated license. At least one instruction causes the computer to enforce the integrated license.

In a further aspect, the present disclosure provides an apparatus for licensing. The apparatus comprises means for detecting a licensable item on a device. The apparatus comprises means for accessing a legacy license associated with the licensable item, wherein the legacy license corresponds to a legacy licensing policy. The apparatus comprises means for accessing a layered license associated with the licensable item, wherein the layered license corresponds to a layered licensing policy. The apparatus comprises means for integrating the legacy licensing policy and the layered licensing policy into an integrated license. The apparatus comprises means for enforcing the integrated license.

In yet another aspect, the present disclosure provides an apparatus for licensing. An invoking component detects a licensable item on a device. A license enforcement component accesses a legacy license associated with the licensable item. The legacy license corresponds to a legacy licensing policy. The license enforcement component further accesses a layered license associated with the licensable item, wherein the layered license corresponds to a layered licensing policy. The license enforcement component additionally integrates the legacy licensing policy and the layered licensing policy into an integrated license, and enforces the integrated license.

To the accomplishment of the foregoing and related ends, the one or more aspects comprise the features hereinafter described in detail and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates a schematic diagram of communication system wherein a layered licensing agent on a communication device intelligently and semi-autonomously can augment legacy license policies or features for licensed content, according to one aspect.

FIG. 2 illustrates a schematic diagram of an apparatus for licensing in a communication environment, according to one aspect.

FIG. 3 illustrates a flow diagram for a method of licensing in a communication environment, according to one aspect.

FIG. 4 illustrates a functional block diagram for a system of logical grouping of electrical components for licensing in a communication environment, according to one aspect.

FIG. 5 illustrates a timing diagram for a first phase of licensable item acquisition, according to one aspect.

FIG. 6 illustrates a timing diagram for a second phase of licensable item acquisition, according to one aspect.

FIG. 7 illustrates a timing diagram for a local license check, according to one aspect.

FIG. 8 illustrates a timing diagram for a remote license check, according to one aspect.

FIG. 9 illustrates a timing diagram for an offline remote license check, according to one aspect.

FIG. 10 illustrates a schematic diagram of an exemplary hardware environment of a user device or mobile device for managing one or more licensed items, according to one aspect.

FIG. 11 illustrates a schematic diagram of an exemplary hardware environment of a network apparatus for managing one or more licensed items, according to one aspect.

### DETAILED DESCRIPTION

Described herein is a layered licensing methodology and apparatus for dynamically modifying an extent of a license, a license policy, or a license feature for a licensable item on a communication device while maintaining baseline license enforcement by a legacy licensing component. In an exemplary aspect, a layered license agent on the communication device, such as a mobile device, may be located at a layer above a legacy licensing component, and provides complementary extensions to the legacy license component in synchronous or asynchronous coordination with a remote license server. In other words, in some aspects, the layered licensing agent may operate in combination with the legacy licensing component to enforce licensing policies from both new and legacy licensing infrastructures/systems. Thereby, a legacy licensing network infrastructure can continue to support a mixed population of mobile devices with a portion only being capable of legacy licensing.

In particular, in one example, a uniform licensing implementation is created for new and old devices, including existing devices having a different (e.g., legacy) licensing scheme. As such, a new licensable item distribution system can address the largest number of devices possible, including those devices already in the field operable with the legacy licensing scheme, while offering expanded opportunities for content and/or service providers and users through a new or layered licensing scheme. For instance, the new licensable item distribution system can include facilities to license a licensable item (e.g., content and/or services) in a variety of ways through the use of a layered license agent that has intelligence to cooperatively enforce new layered licensing policy in combination with the legacy licensing policy.

In other words, the described apparatus and methods of layered licensing can provide a flexible solution that balances complexity and inter-operability. In this manner, implementation details, system analysis, and code re-use may be improved in a licensable item distribution system that can use the same dynamic protections across new and legacy devices versus one where a distinct interoperability-based implementation is required for legacy devices.

In one aspect, layering the new scheme on top of code licensed by the legacy system provides a mechanism for inter-operation between the licensing systems without undue cost and complexity. According to one aspect, in new devices, the layered license agent can use the execution optimizations of the legacy license system while disabling enforcement of legacy licenses by generating valid unlimited use licenses in the legacy system and applying the unlimited use licenses to all licensable items (e.g., content and/or services) protected by the new scheme. As far as the underlying legacy licensing system and management software is aware, all of the newly protected licensable items are fully licensed. Only the new system (e.g., the layered licensing agent) is aware of the restrictions placed on the licenses for the newly protected licensable item. Any licensable item on these devices licensed by the legacy system will continue to function and be completely unaware of the new licensing system that has been added. It should be noted that the unlimited use legacy license is but one example, and that other types of legacy licenses with different policies may be used in conjunction with the layered license agent, such that some license enforcement is managed by the legacy licensing component while other license enforcement is managed by the layered license agent.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

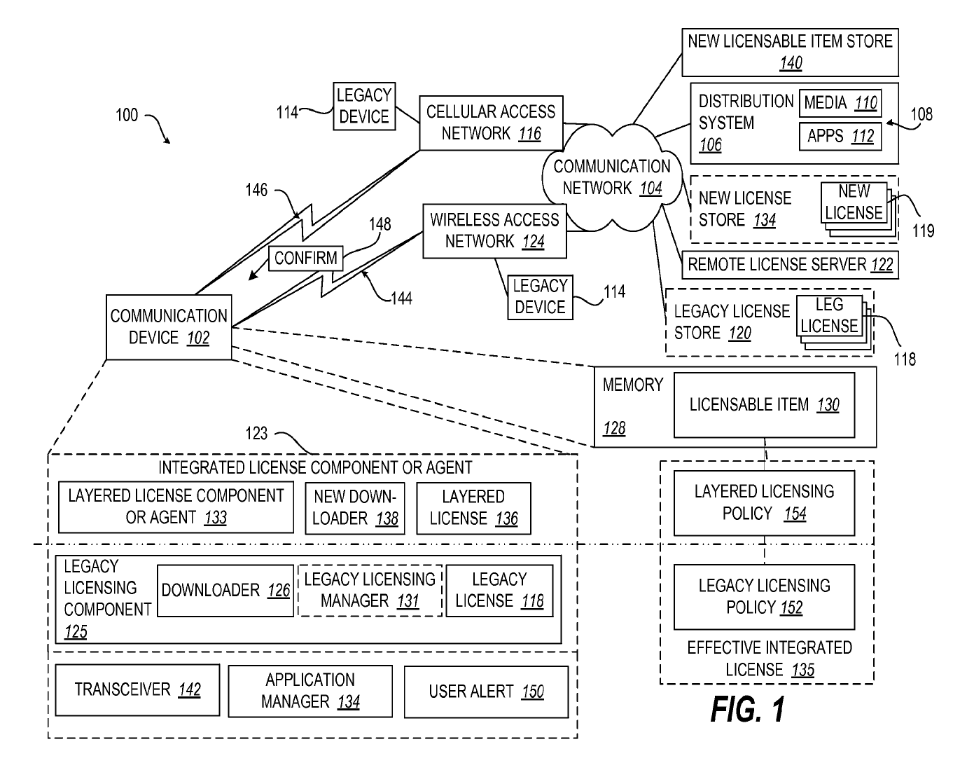

With initial reference to FIG. 1, according to one aspect in a communication environment 100, an aspect of an apparatus, depicted as a mobile device or communication device 102, provides support for acquiring one or more licensable items 130, such as content and/or services, and enforcement of one or more licensing policies corresponding to each licensable item 130. Consistent with one aspect, a communication network 104 includes one or more distribution system(s) 106 for distributing one or more licensable items 108, such as but not limited to media content 110 and application content 112.

It should be noted that as used herein, a “licensable item” may include a content item (“content”) or a service item (“service”), each respectively corresponding to an effective, integrated license 135 having one or more layered licensing policies 154 and one or more legacy licensing policies 152. For instance, each layered licensing policy 154 corresponds to a new licensing scheme or system, for example, while each legacy licensing policy 152 corresponds to a legacy licensing scheme or system. Further, each of the layered licensing policies 154 and the legacy licensing policies 152, for example, may define one or more of a rule, a condition, a parameter, instructions, etc., corresponding to desired licensing enforcement for the respective licensable item 130. Accordingly, the combination of the one or more layered licensing policies 154 and the one or more legacy licensing policies 152 defines the effective, integrated license 135 that may be used by layered licensing component 133 and/or legacy licensing component 125 to perform licensing enforcement for the corresponding licensable item 130.

As used in this disclosure, the term “content” includes, at least, any type of application, multimedia file, image file, executable, program, web page, script, document, presentation, message, data, meta-data, or any other type of media or information that may be rendered, processed, or executed on a device. Also, the term “service” includes, at least, providing of an action or an accommodation, including in electronic or non-electronic form. For example, in one aspect, a service may include providing access, such as access to a network server, access to a physical location such as a building, a restricted area, etc. For instance, in one aspect that should not be construed as limiting, a use case of providing access to a network server may include a scenario where a user is a player in a game, and access is provided to a network server to enable the user to participate in a network-based multi-player service for the game provided by the network server. Additionally, for instance, in an aspect that should not be construed as limiting, a use case of providing access to a physical location may include providing access and/or a membership to a gym.

As used in this disclosure, the term “licensable item” or “licensed item” refers to content, or to a service, or to both, including items that can be used, executed, distributed, accessed, modified, viewed, presented, etc., subject to a license.

Also, as used in this disclosure, the term “license” is used to describe an enabling key, datum, object, policy, or authenticated message that allows use of a licensable item. The license can be a specific implementation of Data Rights Management (DRM) executed by a license agent on the device with at least intermittent coordination with a licensing server. DRM, and thus the term license as used herein, can refer to access control technologies that are used by hardware manufacturers, publishers, copyright holders and individuals to limit the use of digital content such as licensable content and/or services, as well as devices. The license can be used to describe any technology that inhibits uses of licensable content and/or services in a manner that is not desired or intended by an originating or distributing provider. Moreover, as noted above, a license may include one or more policies or policy objects, which may correspondingly define one or more rules, conditions, parameters, or instructions that characterize the license.

The communication network 104 can support legacy devices 114 that acquire one or more of the available licensable items 108 via a cellular access network 116 subject to a legacy license 118 from a legacy license system or legacy license store 120. Alternatively or in addition, legacy devices 114 can receive one or more of the available licensable items 108 via a wireless access network 124.

Similar to the legacy devices 114, the communication device 102 can comprise a legacy licensing component 125 having a downloader 126 for initially provisioning a non-transitory computer-readable storage medium, depicted as a memory 128, of the communication device 102 with licensable item 130 acquired from the available licensable items 108 and subject to a legacy license 118 from the legacy license store 120. One of ordinary skill in the art should appreciate that the provisioning can be made during original manufacture, manual installation, cellular, or wireless download, etc. In an aspect, for example, legacy license 118 may be defined by one or more legacy licensing policies 152. The communication device 102 can utilize a legacy license manager 131 that enables an application manager 132 to use the licensable item 130 according to the one or more legacy licensing policies 152.

Unlike the legacy devices 114, however, the communication device 102 can interact with a new license store 134 to implement advanced licensing terms or features by having a layered license component or layered license agent 133 that can update, modify, augment, enforce, etc., features defined by one or more layered licensing policies 154 associated with a licensable item 130 to define an effective integrated license 135. In an exemplary aspect, the communication device 102 does not access the legacy license store 120, but instead accesses new license store 134 and obtains a new license 119 for the licensable item 130. For example, the obtained new license 119 may be defined by one or more layered licensing policies 154. Correspondingly, in one aspect, the legacy license 118 as defined by one or more legacy licensing policies 152 is set to an unlimited license with a layered license 136 as defined by one or more layered licensing policies 154 providing specific license features (e.g., network connectivity, reporting requirements, allowable uses, etc.) for the licensable item 130.

Specifically, in one aspect, the communication device 102 can require a modification to one or more legacy licensing policies 152 in order to define the effective, integrated license 135 for the licensable item 130. For instance, a feature associated with the licensable item 130 may not have been provided for or may have been expired. Examples can include reporting of a status of a license policy, requiring network connectivity information by a license, or not implementing a timing requirement by the legacy license. Alternatively, the licensable item 130 can require an extension of a legacy licensing policy 152, such as a rule relating to access to a second category of use (e.g., upgrade, update, etc.) from an originally licensed first category of use (e.g., play, execute, present, display, etc.) allowed by the legacy license 118. Alternatively or in addition, the extension may relate to a license parameter defined by a legacy licensing policy 152, such as the term of the integrated license 135 (which may have expired after having been initially unexpired, based upon calendar date), number of uses, cumulative duration of use, etc. So, in this example, the layered license agent 133 may operate to define the effective, integrated license 135 to include the modification or extension, such as for an extended term on the communication device 102 in response to accessing the license that has expired, by obtaining one or more layered licensing policies 152.

Alternatively, a new download component 138 can provision the communication device 102 with the licensable item 130 from a new licensable item store 140 associated with the new license store 134. For instance, the hardware, firmware or software optimization provided by the legacy license manager 131 can be leveraged with a modification or replacement made for an application manager 132 that also looks to the layered license agent 133 for extra functionality. For instance, the legacy license 118 of the licensable item 130 can be unlimited but lack a license feature such as reporting license compliance or allowing an update, which functionality may be provided via layered licensing policy 154 and layered license agent 133.

In some aspects, the layered licensing component or agent 133 working together with, or overriding, the legacy licensing component 125, may be referred to as an integrated licensing component or agent 123. Moreover, according to one example, the layered licensing component or agent 133 or the integrated licensing component or agent 123 may define a single license agent at the device 102 that can enforce all of the licenses, e.g. legacy license 118 and layered license 136, and their corresponding policies, e.g. legacy licensing policy 152 and layered licensing policy 154, for any licensed items, e.g. licensable item 130, used on the device 102. Further, according to an example, such a single license manager or license agent may be configured to operate with different types of content, different types of services, content or services from different licensing authorities or systems, etc. In other words, in this aspect, the layered licensing component or agent 133 or the integrated licensing component or agent 123 may function as a universal or generic license manager or license agent, thereby eliminating or reducing the need for a plurality of different license managers or agents specific to different types of content or services, different licensing authorities, or different licensing systems.

In one aspect, the layered license agent 133 occasionally communicates with the remote license server 122 to reduce network data traffic. For example, the layered license agent 133, via a transceiver 142 of the communication device 102, can update the integrated license 135 after a selected period of time (e.g., hours, days, weeks, months, etc.). Alternatively or in addition, the layered license agent 133 via a transceiver 142 of the communication device 102 can update the integrated license 135 when a low cost or high bandwidth communication channel is available, depicted as a wireless link 144. Alternatively or in addition, the layered license agent 133 via a transceiver 142 of the communication device 102 can update the integrated license 135 on demand or as needed, as depicted via a cellular air link 146, with a confirmation 148 received back from the remote license server 122.

In an exemplary aspect, intelligent modification of the effective, integrated license 135 by the layered license agent 133 can utilize one or more types of communication during content acquisition, local license check, remote license check, or offline remote license check. Thereby, the layered license component 133 can modify the license (e.g., in the case where the legacy license may have expired, to extend the term) by performing a synchronous or asynchronous communication with the remote license server 122 with the request to use pending. For example, asynchronous communication can occur before the request or after the request. For synchronous communication, the layered license agent 133 can generate a user alert 150 for a delay imposed by the synchronous communication.

In one aspect, the communication device 102 can utilize licensable item 130 that is subject to a legacy licensing policy 152 or the layered licensing policy 154, or a combination of the legacy licensing policy 152 and the layered licensing policy 154 (e.g., the effective, integrated license 135).

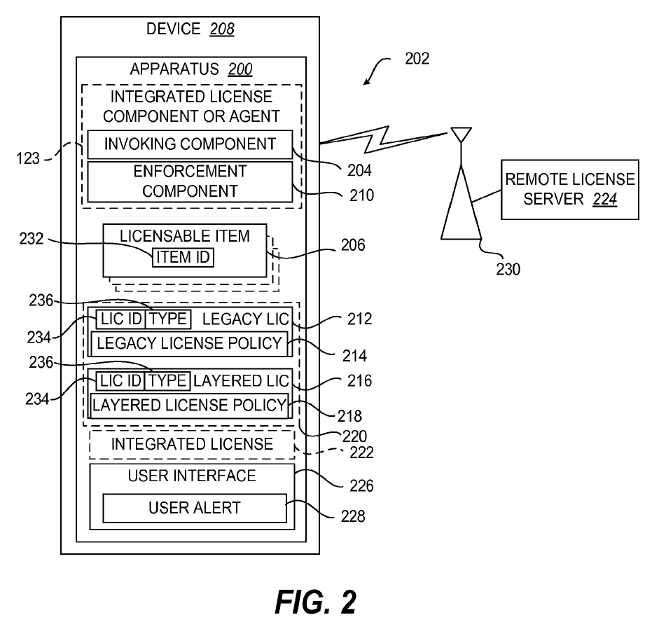

By virtue of the foregoing, in FIG. 2, the present disclosure provides an apparatus 200 (e.g., the communication device 102 (FIG. 1)) which can provide for acquiring and enforcing licensing policy for a licensable item. In an exemplary aspect, licensing is provided in a communication environment 202. An invoking component 204, such as within the integrated licensing agent 123 or the layered license agent 133 described in FIG. 1, detects a licensable item 207, similar to licensable item 130 (FIG. 1), on a device 208. For instance, invoking component 204 may detect a user input received by user interface 226 due to selection of the licensable item 206 (e.g., media content, application content, etc.) for use on the device 208. A license enforcement component 210, such as within the integrated licensing agent 123 or the layered license agent 133 described in FIG. 1, responds to the invoking component 204 by accessing a legacy license 212 associated with the licensable item 206, wherein the legacy license 212 corresponds to a legacy licensing policy 214. The license enforcement component 210 accesses a layered license 216 associated with the licensable item 205, wherein the layered license 216 corresponds to a layered licensing policy 218. The license enforcement component 210 integrates a combination 220 of the legacy licensing policy 214 and the layered licensing policy 218 to define an integrated license 222 (which, although illustrated as a separate component, may merely be defined by combination 220). The license enforcement component 210 enforces the integrated license 222.

In one aspect, the license enforcement component 210 accesses a legacy license 212 that is set as an unlimited license and accesses a layered license 212 that provides for a network communication requirement.

In another aspect, the license enforcement component 210 accesses a legacy license and a layered license 216 that are both locally-stored.

In a further aspect, the license enforcement component 210 integrates the legacy licensing policy 214 and the layered licensing policy 218 by determining a combination of constraints, e.g. policies, imposed by both the legacy license 212 and the layered license 216.

In yet another aspect, the license enforcement component 210 accesses a null result for the legacy licensing policy 214 or the legacy license 212. The license enforcement component 210 thus integrates the legacy licensing policy 214 and the layered licensing policy 218 by determining a constraint imposed only by the layered license 216.

In another aspect, the license enforcement component 210 accesses the layered license 216 by accessing a remote license server 224 to receive at least a portion of the layered licensing policy 218 associated with the layered license 216. For example, the license enforcement component 210 performs a synchronous communication with the remote license server 224 while a request to use the licensable item 205 is pending, which can further include generating a user alert 226 on a user interface 228 for a delay imposed by the synchronous communication. Alternatively, the license enforcement component 210 can perform an asynchronous communication with the remote license server 224 prior to receiving a request to use the licensable item 205. In an additional aspect, the license enforcement component 210 can access the remote license server 224 by communicating via a cellular access node or via a wireless access point 230.

In one aspect, the license enforcement component 210 enforces at least one of a recall, deletion, update, transfer, upgrade, expiration, download or activation of a selected licensable item 206.

In another aspect, for example, the license enforcement component 210 enforces a term update policy of the integrated license 222, and in some aspect may perform updating a current term to one of a future calendar date, an additional duration of time, or an additional enumeration of uses.

In a further aspect, the license enforcement component 210 determines an item identifier 232 corresponding to the licensable item 205 and determines the legacy licensing policy 214 and the layered licensing policy 218 based upon a match between the item identifier 232 and a license identifier 234 corresponding to the licensable item 205. Alternatively, the license enforcement component 210 determines the item identifier 232 corresponding to the licensable item 205 and determines the legacy licensing policy 214 and the layered licensing policy 218 based upon a match between the item identifier 232 and a license type 236 corresponding to the licensable item 205.

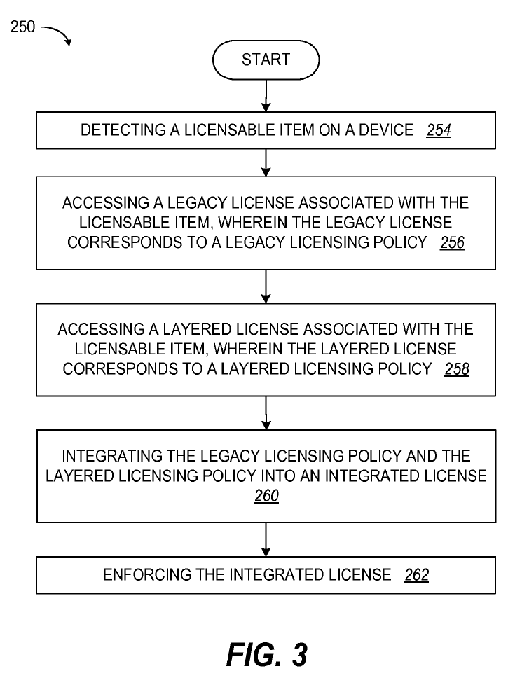

In FIG. 3, a methodology 250 is provided for licensing, according to one aspect. A device detects a licensable item on a device (block 254). The device accesses a legacy license associated with the licensable item, wherein the legacy license corresponds to a legacy licensing policy (block 256). The device accesses a layered license associated with the licensable item, wherein the layered license corresponds to a layered licensing policy (block 258). The device integrates the legacy licensing policy and the layered licensing policy into an integrated license (block 260). The device enforces the integrated license (block 262).

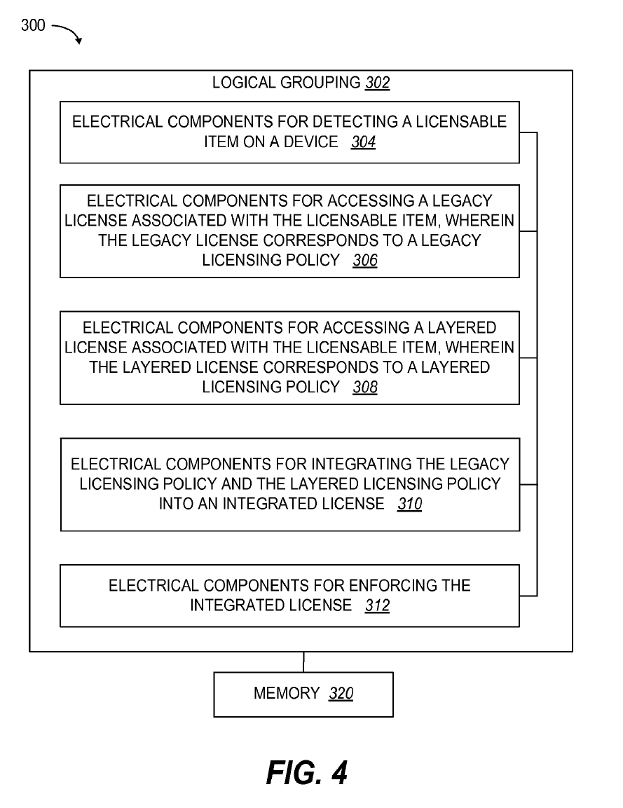

With reference to FIG. 4, illustrated is a system 300 for licensing, according to one aspect. For example, system 300 can reside at least partially within a communication device, mobile device, or user equipment (UE). It is to be appreciated that system 300 is represented as including functional blocks, which can be functional blocks that represent functions implemented by a computing platform, processor, software, or combination thereof (e.g., firmware). System 300 includes a logical grouping 302 of electrical components that can act in conjunction. For instance, logical grouping 302 can include an electrical component 304 for detecting a licensable item on a device. Moreover, logical grouping 302 can include an electrical component 306 for accessing a legacy license associated with the licensable item, wherein the legacy license corresponds to a legacy licensing policy. Further, logical grouping 302 can include an electrical component 308 for accessing a layered license associated with the licensable item, wherein the layered license corresponds to a layered licensing policy. In addition, logical grouping 302 can include an electrical component 310 for integrating the legacy licensing policy and the layered licensing policy into an integrated license. In addition, logical grouping 302 can include electrical component 312 for enforcing the integrated license. Additionally, system 300 can include a memory 320 that retains instructions for executing functions associated with electrical components 304-312. While shown as being external to memory 320, it is to be understood that one or more of electrical components 304-312 can exist within memory 320.

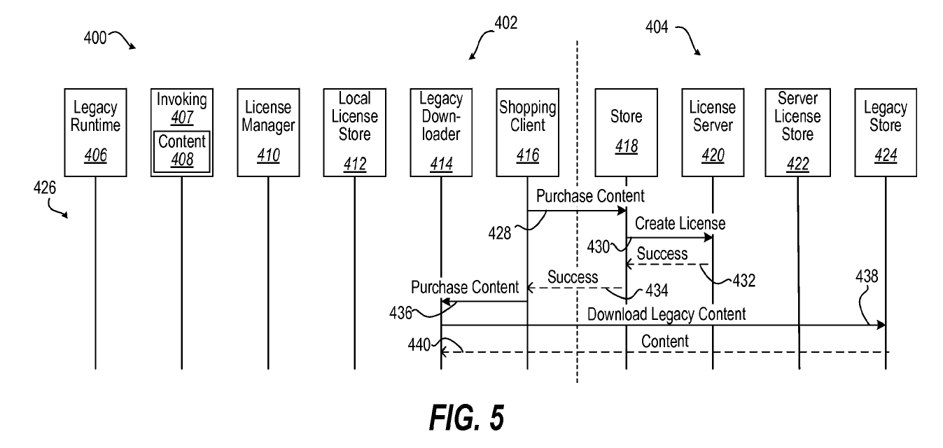

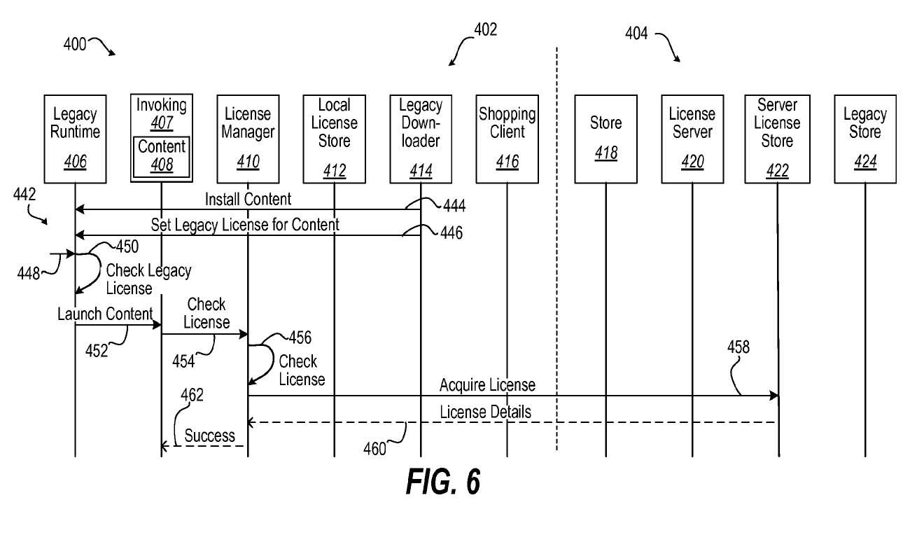

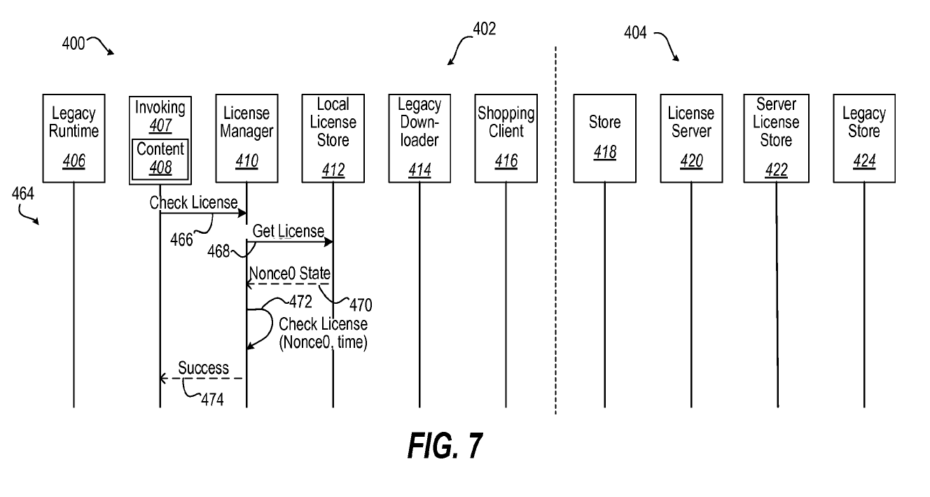

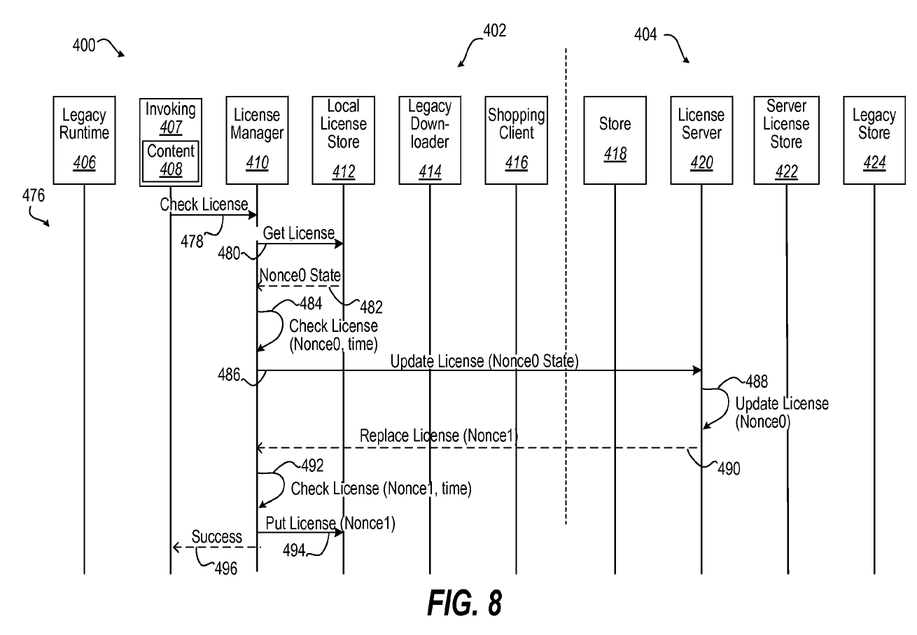

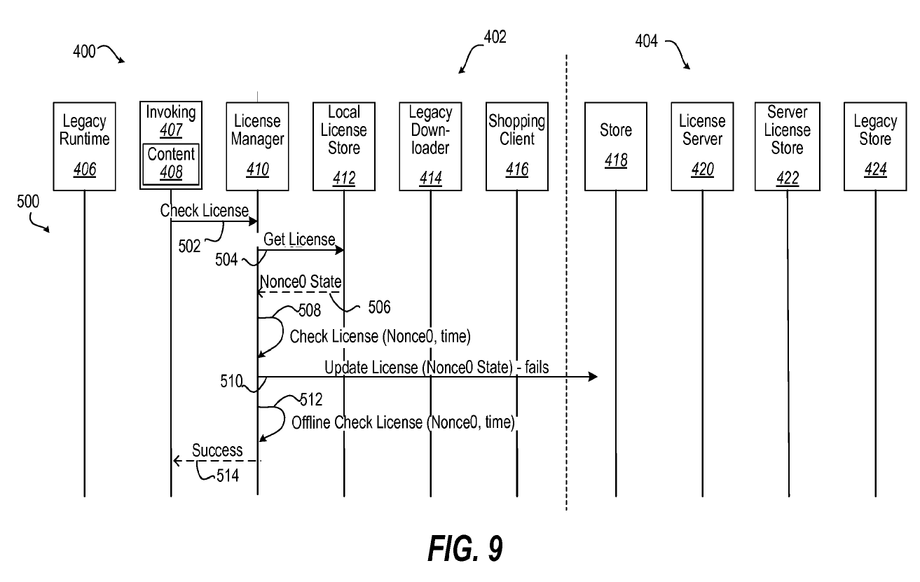

In FIGS. 5-9, a communication system 400 of a communication device 402 and a network 404 is depicted for licensing in a communication environment, according to one aspect. FIGS. 5-9 are described with reference to a licensable item in the form of content, however, it is to be understood that a service may be substituted for content, or that both content and services may be included. In particular, a first phase of content acquisition (FIG. 5), a second phase of content acquisition (FIG. 6), local license check (FIG. 7), remote license check (FIG. 8), and offline remote license check (FIG. 9) are depicted. In one example, the communication device 402 comprises a legacy runtime 406, an invoking component 407 for content 408, license manager 410, local license store 412, legacy downloader 414, and shopping client 416. According to one aspect, the network 404 comprises a store 418, license server 420, server license store 422, and a legacy store 424.

In one aspect, the invoking component 407 can be, for instance, a control component, an application manager (e.g., legacy or layered), a license manager, a content launcher, etc.

With particular reference to FIG. 5, a methodology 426 for content acquisition (phase 1) is depicted, according to one aspect. The shopping client 416 communicates with the store 418 to purchase content as depicted at 428. The store 418 communicates with the license server 420 to create a license as depicted at 430. The license server 420 communicates success to the store 418 as depicted at 432. The store 418 in turn reports success to the shopping client 416 as depicted at 434. The shopping client 416 informs the legacy downloader 414 of the purchase of content as depicted at 436. The legacy downloader 414 communicates with the legacy store 424 to download legacy content, e.g., a licensable item 130 having a legacy licensing policy 152 as described with respect to FIG. 1, as depicted at 438. The legacy store 424 responds to the legacy downloader 414 by downloading the content as depicted at 440.

With particular reference to FIG. 6, a methodology 442 is depicted for content acquisition (phase 2), according to one aspect. The legacy downloader 414 installs the content for the legacy runtime 406 as depicted at 444. The legacy downloader 414 sets the legacy license for the content for the legacy runtime 406 as depicted at 446. When the invoking component 407 selects to use content 408 as depicted at 448, the legacy runtime 406 performs a license check as depicted at 450 and launches the content 408 as depicted at 452. The content 408 or application that consumes the content 408 checks the license with the license manager 410 as depicted at 454. The license manager 410 performs a check of the license as depicted at 456. In one aspect, the license manager communicates with the server license store 422 to acquire a license as depicted at 458, which in turn responds with license details as depicted at 460. The license manager 410 then reports success to the content 408.

With particular reference to FIG. 7, a methodology 464 is depicted for a local license check, according to one implementation. The content 408 communicates with the license manager 410 to check the license as depicted at 466. The license manager 410 communicates with the local license store 412 to get the license as depicted at 468, which responds with a Nonce0 state as depicted at 470. The license manager 410 checks the license with Nonce0 state given the current time as depicted at 472. The license manager 410 can report success to the content 408 as depicted at 474.

With particular reference to FIG. 8, a methodology 476 is depicted for a remote license check, according to one aspect. The content 408 communicates with the license manager 410 to check the license as depicted at 478. The license manager 410 communicates with the local license store 412 to get the license as depicted at 480, which responds with a Nonce0 state as depicted at 482. The license manager 410 checks the license with Nonce0 state given the current time as depicted at 484. In this instance, an update of the license is warranted. As such, the license manager 410 communicates with the license server 420 with a request to update license having Nonce0 state as depicted at 486. The license server 420 updates the license of state Nonce0 as depicted at 488 and communicates with the license manager 410 to replace the license with a license of Nonce1 state as depicted at 490. The license manager 410 checks the license with Nonce1 state given the current time as depicted at 492. The license manager 410 communicates with the local license store 412 to put the license with Nonce1 state into local storage as depicted at 494. Then the license manager 410 can report success to the content 408 as depicted at 496.

With particular reference to FIG. 9, a methodology 500 is depicted for an offline remote license check, according to one aspect. The content 408 communicates with the license manager 410 to check the license as depicted at 502. The license manager 410 communicates with the local license store 412 to get the license as depicted at 504, which responds with a Nonce0 state as depicted at 506. The license manager 410 checks the license with Nonce0 state given the current time as depicted at 508. In this instance, an update of the license is warranted. Therefore, the license manager 410 attempts but fails to communicate with the license server 420 with a request to update license having Nonce0 state as depicted at 510. The license manager 410 performs an offline check of the license using state Nonce0 and the current time as depicted at 512. Then the license manager 410 can report success to the content 408 as depicted at 514.

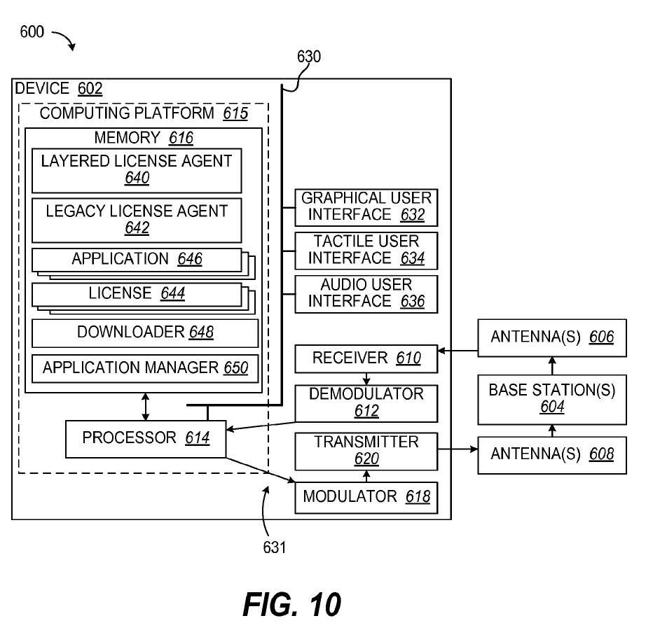

FIG. 10 is a block diagram of another system 600 that can be utilized to implement various aspects of the functionality described herein. In one example, system 600 includes a mobile terminal, user device, communication device, or mobile device 602. As illustrated, mobile device 602 can receive signal(s) from one or more base stations 604 via one or more receive (Rx) antennas 606 and transmit to the one or more base nodes or stations 604 via one or more transmit (Tx) antennas 608. Additionally, mobile device 602 can comprise a receiver 610 that receives information from receive antenna(s) 606. In one example, the receiver 610 can be operatively associated with a demodulator 612 that demodulates received information. Demodulated symbols can then be analyzed by a processor 614. Processor 614 of a computing platform 615 can be coupled to memory 616, which can store information related to code clusters, access terminal assignments, lookup tables related thereto, unique scrambling sequences, and/or other suitable types of information. In one example, mobile device 602 can also include a modulator 618 that can multiplex a signal for transmission by a transmitter 620 through transmit antenna(s) 608. The receiver 610 and transmitter 620 can cooperatively function as a transceiver 631. Databus 630 can interface the processor 614 to a graphical user interface 632, a tactile user interface 634, and an audio user interface 636.

In memory 616, a layered license agent 640 can augment a legacy license component 642 by modifying license 644 for content, depicted as an application 646 that were downloaded by downloader 648. An application manager 650 manages use, update, upgrade, deletion, etc., of the application 646.

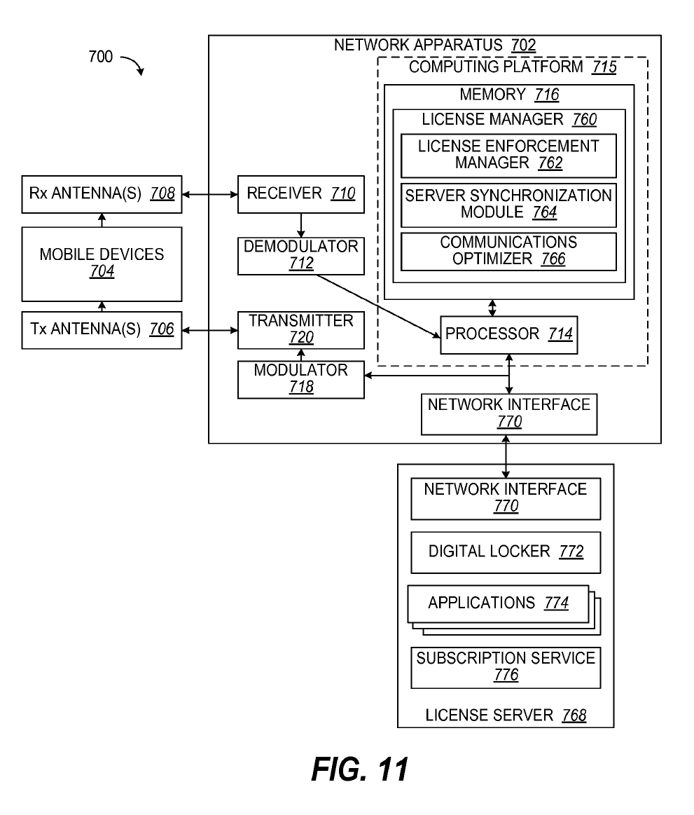

FIG. 11 is a block diagram of a system 700 that can be utilized to implement various aspects of the functionality described herein. In one example, system 700 includes a network apparatus 702 (e.g., base node or station). As illustrated, network apparatus 702 can receive signal(s) from one or more mobile devices 704 and transmit to the one or more mobile devices 704 via one or more antennas 706. Additionally, network apparatus 702 can comprise a receiver 710 that receives information from antenna(s) 708. In one example, receiver 710 can be operatively associated with a demodulator 712 that demodulates received information. Demodulated symbols can then be analyzed by a processor 714. Processor 714 of a computing platform 715 can be coupled to memory 716, which can store data and/or program codes related to network apparatus 702. Additionally, network apparatus 702 can employ processor 714 to perform methodologies described herein such as a license manager 760 having components of a license enforcement manager 762, server synchronization module 764, and communications optimizer 766. Network apparatus 702 can also include a modulator 718 that can multiplex a signal for transmission by a transmitter 720 through antenna(s) 706. In an exemplary aspect, some functions for supporting the mobile devices 704 for licensed content is performed remote to the network apparatus 702, depicted as a network server 768 communicating via network interfaces 770 and providing services of a digital locker 772, a repository of applications 774 for download, and subscription services 776.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In addition, the term application as used herein refers to computer software program in general and can further encompass data, configuration settings, etc., used by the computer software program. Examples include utilities such as e-mail, Short Message Service (SMS) text utility, chat interface, web browsers, calculators, viewers, media players, games, etc. In an exemplary aspect, application can refer to software that is suitable for use on a mobile device, especially to being downloaded via a Wireless Local Access Network (WLAN) or Wireless Wide Area Network (WWAN).

For clarity, examples herein denote applications that are locally stored on user equipment, mobile devices, handset, access terminals, etc. However, implementations can encompass applications that are remotely stored. Similarly, for clarity distributing of the applications to the mobile devices can be described as being wirelessly downloaded from a WWAN or WLAN or P2P. However, implementations can include wired distribution, manual insertion of non-transitory computer readable storage medium, and unlocking a previously installed software object.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

1. A method for licensing, comprising:
detecting a licensable item on a device;
accessing a legacy license associated with the licensable item, wherein the legacy license corresponds to a legacy licensing policy, and wherein the legacy licensing policy permits unlimited use of the licensable item;
accessing a layered license associated with the licensable item, wherein the layered license corresponds to a layered licensing policy, and wherein the layered licensing policy provides a licensing feature not provided by the unlimited use of the licensable item permitted by the legacy licensing policy;
integrating the legacy licensing policy and the layered licensing policy into an integrated license, wherein integrating the legacy licensing policy and the layered licensing policy causes the unlimited use of the licensable item permitted by the legacy licensing policy to be extended according to the licensing feature provided by the layered licensing policy; and
enforcing the integrated license by a legacy licensing component operating in combination with a layered licensing component, wherein the legacy licensing component manages features of the licensable item governed by the legacy license and the layered licensing component manages features of the licensable item governed by the layered license.

2. The method of claim 1, wherein detecting the licensable item further comprises detecting a selection of the licensable item.

3. The method of claim 1, wherein the licensing feature not provided by the unlimited use of the licensable item permitted by the legacy licensing policy comprises access to a network communication requirement, non-implementation of an expiration of the legacy license, reporting of a status of a licensing policy, or any combination thereof.

4. The method of claim 1, wherein accessing the legacy license further comprises accessing a locally-stored legacy license, and wherein accessing the layered license further comprises accessing a locally-stored layered license.

5. The method of claim 1, wherein integrating the legacy licensing policy and the layered licensing policy further comprises determining a combination of constraints imposed by both the legacy license and the layered license.

6. The method of claim 1, wherein accessing the legacy license and the legacy licensing policy provides a null result, and wherein integrating the legacy licensing policy and the layered licensing policy further comprises determining a constraint imposed by the layered license.

7. The method of claim 1, wherein accessing the layered license further comprises accessing a remote license server to receive at least a portion of the layered licensing policy associated with the layered license.

8. The method of claim 7, wherein accessing the remote license server further comprises performing a synchronous communication with the remote license server while a request to use the licensable item is pending.

9. The method of claim 8, further comprises generating a user alert for a delay imposed by the synchronous communication.

10. The method of claim 7, wherein accessing the remote license server further comprises performing an asynchronous communication with the remote license server prior to receiving a request to use the licensable item.

11. The method of claim 7, wherein accessing the remote license server further comprises communicating via a cellular access node or via a wireless access point.

12. The method of claim 1, wherein enforcing the integrated license further comprises enforcing a selected one of a recall, deletion, update, transfer, upgrade, expiration, download or activation of the licensable item.

13. The method of claim 12, wherein enforcing the expiration of the integrated license comprises updating a current term to one of a future calendar date, additional duration of time, and an additional enumeration of uses.

14. The method of claim 1, wherein the licensable item comprises one of media content or application content or a service.

15. The method of claim 1, wherein accessing the legacy license and the layered license both associated with the licensable item further comprises:
determining an item identifier corresponding to the licensable item; and
determining the legacy licensing policy and the layered licensing policy based upon a match between the item identifier and a license identifier corresponding to the licensable item.

16. The method of claim 1, wherein accessing the legacy license associated with the licensable item and accessing the layered license associated with the licensable item further comprises:
determining an item type corresponding to the licensable item; and
determining the legacy licensing policy and the layered licensing policy based upon a match between the item type and a license type corresponding to the licensable item.

17. A computer program product for licensing, comprising:
a non-transitory computer-readable storage medium for storing instructions comprising:
at least one instruction for causing a computer to detect a licensable item on a device;
at least one instruction for causing the computer to access a legacy license associated with the licensable item, wherein the legacy license corresponds to a legacy licensing policy, and wherein the legacy licensing policy permits unlimited use of the licensable item;
at least one instruction for causing the computer to access a layered license associated with the licensable item, wherein the layered license corresponds to a layered licensing policy, and wherein the layered licensing policy provides a licensing feature not provided by the unlimited use of the licensable item permitted by the legacy licensing policy;
at least one instruction for causing the computer to integrate the legacy licensing policy and the layered licensing policy into an integrated license, wherein integration of the legacy licensing policy and the layered licensing policy causes the unlimited use of the licensable item permitted by the legacy licensing policy to be extended according to the licensing feature provided by the layered licensing policy; and
at least one instruction for causing the computer to enforce the integrated license by causing a legacy licensing component to operate in combination with a layered licensing component, wherein the legacy licensing component manages features of the licensable item governed by the legacy license and the layered licensing component manages features of the licensable item governed by the layered license.

18. An apparatus for licensing, comprising:
means for detecting a licensable item on a device;
means for accessing a legacy license associated with the licensable item, wherein the legacy license corresponds to a legacy licensing policy, and wherein the legacy licensing policy permits unlimited use of the licensable item;
means for accessing a layered license associated with the licensable item, wherein the layered license corresponds to a layered licensing policy, and wherein the layered licensing policy provides a licensing feature not provided by the unlimited use of the licensable item permitted by the legacy licensing policy;
means for integrating the legacy licensing policy and the layered licensing policy into an integrated license, wherein integration of the legacy licensing policy and the layered licensing policy causes the unlimited use of the licensable item permitted by the legacy licensing policy to be extended according to the licensing feature provided by the layered licensing policy; and
means for enforcing the integrated license by causing a legacy licensing component to operate in combination with a layered licensing component, wherein the legacy licensing component manages features of the licensable item governed by the legacy license and the layered licensing component manages features of the licensable item governed by the layered license.

19. An apparatus for licensing, comprising:
an invoking component for detecting a licensable item on a device; and
a license enforcement component configured to:
access a legacy license associated with the licensable item, wherein the legacy license corresponds to a legacy licensing policy, and wherein the legacy licensing policy permits unlimited use of the licensable item,
access a layered license associated with the licensable item, wherein the layered license corresponds to a layered licensing policy, and wherein the layered licensing policy provides a licensing feature not provided by the unlimited use of the licensable item permitted by the legacy licensing policy,
integrate the legacy licensing policy and the layered licensing policy into an integrated license, wherein integration of the legacy licensing policy and the layered licensing policy causes the unlimited use of the licensable item permitted by the legacy licensing policy to be extended according to the licensing feature provided by the layered licensing policy, and
enforce the integrated license by a legacy licensing component operating in combination with a layered licensing component, wherein the legacy licensing component manages features of the licensable item governed by the legacy license and the layered licensing component manages features of the licensable item governed by the layered license.

20. The apparatus of claim 19, wherein the invoking component is further configured to detect the licensable item by detecting a selection of the licensable item.

21. The apparatus of claim 19, wherein the licensing feature not provided by the unlimited use of the licensable item permitted by the legacy licensing policy comprises access to a network communication requirement, non-implementation of an expiration of the legacy license, reporting of a status of a licensing policy, or any combination thereof.

22. The apparatus of claim 19, wherein the license enforcement component is further configured to access the legacy license by accessing a locally-stored legacy license, and wherein accessing the layered license further comprises accessing a locally-stored layered license.

23. The apparatus of claim 19, wherein the license enforcement component is further configured to integrate the legacy licensing policy and the layered licensing policy by determining a combination of constraints imposed by both the legacy license and the layered license.

24. The apparatus of claim 20, wherein the license enforcement component is further configured to access the legacy license and the legacy licensing policy that provides a null result, and wherein the license enforcement component is further configured to integrate the legacy licensing policy and the layered licensing policy by determining a constraint imposed by the layered license.

25. The apparatus of claim 20, wherein the license enforcement component is further configured to access the layered license by accessing a remote license server to receive at least a portion of the layered licensing policy associated with the layered license.

26. The apparatus of claim 20, wherein the license enforcement component is further configured to enforce the integrated license by enforcing at least one of a recall, deletion, update, transfer, upgrade, expiration, download or activation of the licensable item.

27. The apparatus of claim 26, wherein the license enforcement component is further configured to enforce the expiration of the integrated license by updating a current term to one of a future calendar date, additional duration of time, and an additional enumeration of uses.

28. The apparatus of claim 20, wherein the licensable item comprises one of media content or application content or a service.

29. The apparatus of claim 20, wherein the license enforcement component is further configured to access the legacy license associated with the licensable item and the layered license associated with the licensable item by:
determining an item identifier corresponding to the licensable item; and
determining the legacy licensing policy and the layered licensing policy based upon a match between the item identifier and a license identifier corresponding to the licensable item.

30. The apparatus of claim 20, wherein the license enforcement component is further configured to access the legacy license and the layered license both associated with the licensable item by:
determining an item type corresponding to the licensable item; and
determining the legacy licensing policy and the layered licensing policy based upon a match between the item type and a license type corresponding to the licensable item.
